(19) United States
(12) Patent Application Publication
(10) Pub. No.: US 2005/0122206 A1
(43) Pub. Date: Jun. 9, 2005

(54) Heated structural element with a carrier material

(76) Inventor: Martina Reichel, Weissenstadt (DE)

Correspondence Address: WILLIAM COLLARD;COLLARD & ROE, P.C., 1077 NORTHERN BOULEVARD, ROSLYN, NY, 11576, US

(21) Appl. No.: 10/954,961

(22) Filed: Sep. 30, 2004

(30) Foreign Application Priority Data
Oct. 1, 2003 (DE) 103 45 901.4

(51) Int. Cl. H01C 10/14

(52) U.S. Cl. 338/210; 338/208; 338/212

(57) ABSTRACT

The invention relates to a heated component having a carrier material that is covered with a knitted fabric, which knitted fabric contains at least one electrically at least partially conductive resistor filament and at least one filament that can be optically, thermally, or chemically activated, and which knitted fabric is bonded to the carrier material by means of optical, thermal, or chemical activation of the filament. The invention also relates to a method for the production of such a component.

The present invention relates to a heated component having a carrier material.

In the motor vehicle industry, there is a trend towards high-quality interior equipment, in which the heating of various components, such as mirrors, seats, child seats, or steering wheels is required.

In the case of operator-oriented elements in the interior, such as seats and steering wheels, a resistor wire is generally sewn onto a non-woven fabric and applied under a leather layer, which is held on a carrier material made, for example, of fabric or of wood or plastic. A type of double-sided adhesive tape is used for producing the bond, for example. The disadvantage of this technique consists in the fact that placement of the resistor filament must be designed differently for every individual carrier material and also differently for the interior and exterior. Furthermore, placement of the heating layer is complicated when using this known technology.

It is therefore the task of the invention to create a heated component in which the heating layer is independent of the material of the component and the area of use, to a great extent, and can be easily and reliably applied.

This task is accomplished by means of a heated component as recited in claim 1 and a method for the production of a heated component as recited in claim 14. Advantageous further developments of the invention are the object of the dependent claims.

According to the invention, a knitted fabric is applied to the heated component, which knitted fabric has at least one resistor wire and at least one filament that can be activated, which filament can be activated by means of physical or chemical effects such as light, heat, or certain initiators. The resistor filament can serve both to generate heat and to supply electricity. However, separate electricity feed wires can also be provided. In this case, the resistor filament and the electricity feed wires can be bound into the knitted fabric in different ways.

The application of the knitted fabric to the carrier material is carried out by means of corresponding activation of the filament. The filament develops very good adhesion properties on the carrier material by means of the activation, and thereby results in an intimate bond between the knitted fabric and the filament.

Preferably, the carrier material is slightly roughened or chemically conditioned on the side facing the knitted fabric, in order to facilitate the adhesion properties of the knitted fabric that result from activation of the filament. Possibilities are coating the carrier material with an adhesion-imparting agent, if necessary also a fabric that can be activated in the same manner as the filament of the knitted fabric, which can be activated.

By means of this technique, it is possible to produce a steering wheel covered with knitted fabric, which can be heated, as well as to produce an electrically heated exterior mirror. The area of use of this technique of applying a knitted fabric for heating, by means of activation of at least one knitted fabric filament that can be activated, is therefore not limited to the interior or the exterior or to specific carrier materials. Therefore all kinds of films, strips, as well as hard materials such as plastics, wood, or metal, or combinations of them, or compounds can be used as carriers. Therefore it is equally possible to heat an armrest with a thermally or chemically applied knitted fabric as to heat a headrest or a steering wheel.

Furthermore, uses in medicine as well as the office sector are possible, where a defined supply of heat to lounge furniture or seat furniture or in the therapeutic sector is demanded, e.g. for a cot, where the resistor filament is preferably silicone-coated.

The knitted fabric can be a conventional polymer knit, e.g. polyethylene or polyacrylic. The resistor filament can be configured as a shot filament or a stationary filament in a type of woven knitted goods, i.e. in a knitted fabric having woven components, or the resistor wire can also be knitted in, in the form of knitted stitches and float stitches, as well as in the form of loops and float stitches. If an additional carrier filament is used aside from the resistor filament, the former preferably consists of a material that is heat-resistant. Other than that, the carrier filaments also knitted in can consist of conventional polymer filaments, leather filaments, or natural filaments, or of mixtures of the two.

The resistor wire can be a conventional electrically conductive wire, the size and specific resistance of which are adapted to the requirements of the purpose of use. Instead of a resistor wire, a polymer filament or natural filament or mixed filament wrapped with the resistor wire or coated with an electrically conductive material can also be used.

It is fundamentally possible to use a continuous filament for the entire knitted fabric. If zone-by-zone heating is desired, the resistor filament can also be knitted into certain zones of the knitted fabric using the intarsia technique, and this is probably of particular interest for the medical sector and for molded parts for various tasks.

Conventional hot-melt filaments can be used as the filament that can be activated; these develop adhesive properties at a certain temperature, which properties gradually disappear again after the treatment.

All conventional knitted fabrics can be used as the type of knitted fabric, depending on the area of use, such as knit/purl knitted fabric, knit/knit knitted fabric, or purl/purl knitted fabric.

It is possible to knit the knitted fabric with a three-dimensional contour, to adapt it to the carrier material. In this case, the knitted fabric preferably contains at least two layers and preferably, the number of stitches, i.e. the gauge, and/or the material in the two layers is different, so that overall, a three-dimensional structure of the finished knitted fabric is achieved, which fabric then follows the contour of the carrier material, without applying mechanical forces.

Where a specific optical effect is desired, the knitted fabric can be knit in a corresponding manner, for example it can contain knitted fabric components such as leather filaments, which result in a desired optical effect.

The invention will be explained in greater detail below, using several exemplary embodiments, which are shown in the drawing. The drawing shows:

FIG. 1 a knitted fabric arranged between two parts of a carrier material;

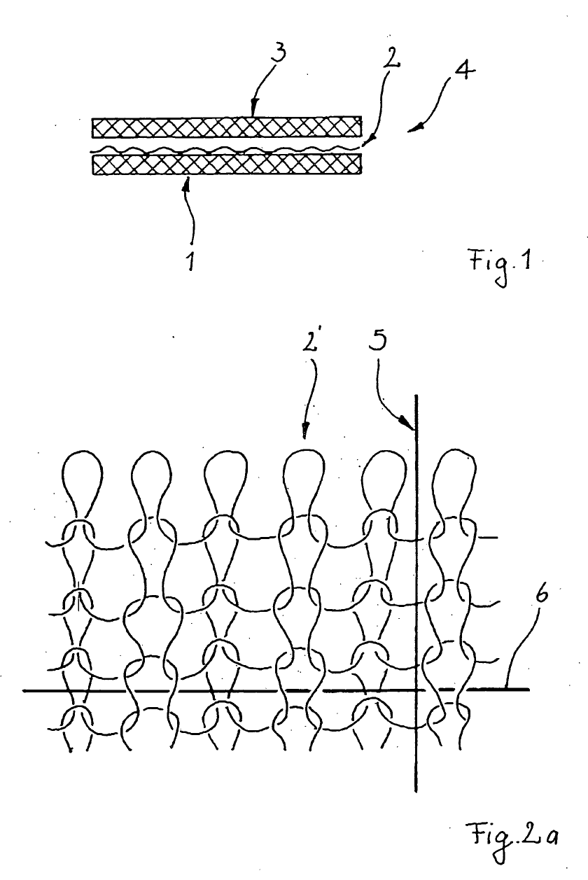

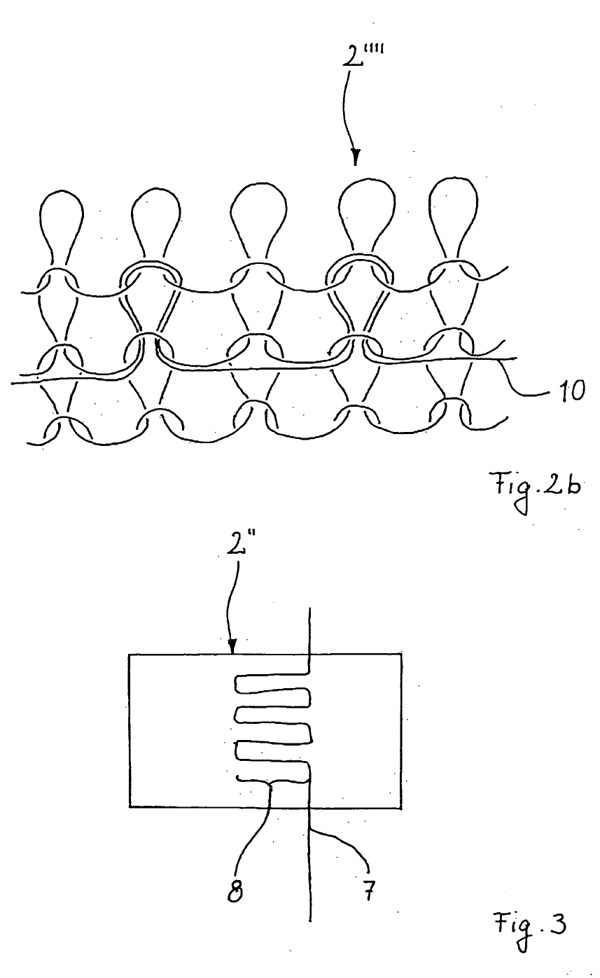

FIG. 2a two possible ways of including resistor filaments in a basic knitted fabric;

FIG. 2b another possibility of including a resistor filament;

FIG. 3 a knitted fabric having a resistor wire, introduced using the intarsia technique;

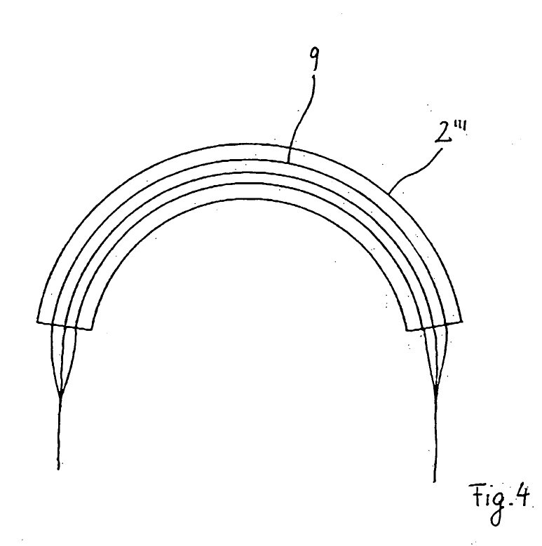

FIG. 4 a shaped knitted fabric with resistor filaments introduced as stationary filaments.

FIG. 1 schematically shows a lower part 1 made of a carrier material, such as wood, having a knitted fabric 2 arranged on its top, in which fabric there are resistor filaments, not shown in detail. Above the lower part 1 of the carrier material there is an upper part 3, again made of the carrier material. The knitted fabric 2 contains a filament that can be thermally activated, not shown in detail. To bond the knitted fabric 2 both with the lower part 1 and with the upper part 3 of the carrier material, the entire arrangement of the three aforementioned components is pressed together, on the one hand, and heated, on the other hand. As a result, the filaments in the knitted fabric, which can be activated, develop their adhesive strength, which has the result that the components enter into an intimate bond with one another and thus form a cohesive component 4, for example a steering wheel.

FIG. 2a shows a knitted fabric 2′ that is implemented as a knit/knit knitted fabric. Here, a resistor filament 5 is worked in as the stationary filament and/or a resistor filament 6 is worked in as a shot filament. In order to be able to use non-insulated resistor filaments 5, 6, and nevertheless avoid a short circuit between the individual power circuits of the resistor filaments 5, 6, it is generally practical to work the resistor filaments 5, 6 in either as stationary filaments or as shot filaments.

FIG. 2b shows a knitted fabric 2″″ in which a resistor filament 10 is alternately worked into a stitch and then floats.

As an alternative to the aforementioned inclusion technique, it is also possible to introduce a resistor filament 7 into a basic knitted fabric 2″ using the known intarsia technique, as shown in FIG. 3. The knitted fabric 2″ is therefore an intarsia knitted fabric in which the resistor wire is placed in such a manner that defined regions in the knitted fabric 2″ can be heated.

Finally, in FIG. 4, another knitted fabric 2′″ is shown, which is a shaped knitted fabric that possesses an arc-shaped form. The shaped knitted fabric contains resistor filaments 9 that are worked into the knitted fabric as stationary filaments. The knitted fabric 2′″ serves, in particular, to be combined with a carrier material in the form of a steering wheel. Two knitted fabrics 2′″ are required in order to cover a steering wheel, which is generally circular, on its outside.

All of the knitted fabrics 2, 2′, 2″, 2′″, 2′″ contain the filaments provided according to the invention, which can be activated optically, thermally, or chemically, in order to be able to bring about a very durable bond with the carrier material, in simple manner.

1. Heatable component (4) having a carrier material that is covered with a knitted fabric (2, 2′, 2″, 2′″, 2″″), which knitted fabric contains at least one electrically at least partially conductive resistor filament (5, 6, 7, 9, 10) and at least one filament that can be optically, thermally, or chemically activated, which knitted fabric (2, 2′, 2″, 2′″, 2″″) is bonded to the carrier material by means of optical, thermal, or chemical activation of the filament that can be activated.

2. Component as recited in claim 1, wherein the component (4) is a steering wheel.

3. Component as recited in claim 1, wherein the knitted fabric (2, 2′, 2″, 2′″, 2″″) contains at least one leather filament.

4. Component as recited in claim 1, wherein the resistor filament (5, 6, 7, 9, 10) contains polymer filaments or natural filaments.

5. Component as recited claim 1, wherein the resistor filament (10) is knit into stitches of the knitted fabric (2″″) and laid to float.

6. Component as recited in claim 1, wherein the resistor filament is knitted in loops and float stitches.

7. Component as recited in claim 1, wherein the resistor filament (5, 6, 7, 9, 10) is formed by an electrically at least partially conductive wire or by a filament wrapped with wire.

8. Component as recited in claim 1, wherein the resistor filament (5, 6, 7, 9, 10) is coated with silicone.

9. Component as recited in claim 1, wherein the resistor filament (5, 6) is guided as a shot filament or stationary filament in the knitted fabric.

10. Component as recited in claim 1, wherein the filament that can be activated is an adhesive filament.

11. Component as recited in claim 1, wherein the knitted fabric (2, 2′, 2″, 2′″, 2″″) has multiple layers and is shaped or contoured three-dimensionally.

12. Component as recited in claim 11, wherein the number and/or density and/or material of the knitted fabric (2, 2′, 2″, 2′″, 2″″) is different in the two layers.

13. Component as recited in claim 1, wherein the carrier material consists of wood, metal, or plastic, hard form or a compound of these materials.

14. Method for the production of a heatable component (4) having a carrier material, a knitted fabric (2, 2′, 2″, 2′″, 2″″) comprising at least one resistor filament (5, 6, 7, 8, 10), and at least one filament that can be thermally, or chemically activated, which knitted fabric (2, 2′, 2″, 2′″, 2″″) is bonded to the carrier material by means of optical, thermal, or chemical activation of the filament that can be activated.
